(19) United States
(12) Patent Application Publication
(10) Pub. No.: US 2006/0161634 A1
(43) Pub. Date: Jul. 20, 2006

(54) Positioning systems and methods for portable devices

(75) Inventor: Ruey-Yuan Tseng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/235,913

(22) Filed: Sep. 27, 2005

(30) Foreign Application Priority Data
Jan. 14, 2005 (TW) 94101126

(51) Int. Cl. G06F 15/16

(52) U.S. Cl. 709/217; 709/223

(57) ABSTRACT

Positioning systems and methods for portable devices. The system comprises a plurality of access points, at least one portable device, and a service provider. Each access point has identification and set at a location. The portable device has identification, and wirelessly couples to a network provided by the service provider via one of the access points. The service provider has a database comprising access point information and at least one access record. The access point information records the identification and locations corresponding to respective access points. The access record records at least the identification of the portable device and the identification of the access point coupled thereto. The service provider determines the location information of the portable device according to the access point information and the access record.

### BACKGROUND

The present disclosure relates generally to positioning systems and methods, and, more particularly, to systems and methods that dynamically determine location information for portable devices.

With the popularization of wireless networking, portable devices, such as computer systems, PDAs, and mobile phones can wirelessly connect to a service provider via access points, and access a TCP/IP network or an Internet via the service provider.

The varying locations of the portable devices make it critical to manage and provide services for specific portable devices. Additionally, when a request for the location of a specific portable device is received by the service provider, no efficient mechanism is provided to query and trace the location information of the portable device.

### SUMMARY

Positioning systems and methods for portable devices are provided.

An embodiment of a positioning system for portable devices comprises a plurality of access points, at least one portable device, and a service provider. Each access point has identification and set at a location. The portable device has identification, and wirelessly couples to a network provided by the service provider via one of the access points. The service provider has a database comprising access point information and at least one access record. The access point information records the identifications and locations corresponding to respective access points. The access record records at least the identification of the portable device and the identification of the access point coupled thereto. The service provider determines the location information of the portable device according to the access point information and the access record.

The access record further records an access time, and the service provider further determines the location information of the portable device at the access time according to the access point information and the access record.

Respective access points further update corresponding identification and locations to the service provider.

The access record is generated when the portable device couples to the network provided by the service provider via the access point.

The database further records user information corresponding to the identification of the portable device. The service provider further receives specific user information, and retrieves the corresponding location information according to the identification of the portable device corresponding to the specific user information, the access record and the access point information.

In an embodiment of a positioning method for portable devices, a location query for a specific portable device is received. At least one access record comprising identification of the specific portable device is retrieved from a plurality of access records. The access record is generated when the portable device wirelessly couple to a network via one access point, and the access record records at least the identification of the portable device and the identification of the access point coupled thereto. The identification of a specific access point is retrieved from the access record. A location corresponding to the specific access point is retrieved from access point information according to the identification of the specific access point, such that the location information of the specific portable device is determined accordingly. The access point information records the identification and location corresponding to the access point.

Positioning methods for portable devices may take the form of program code embodied in tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a positioning system for portable devices;

FIG. 2 is a schematic diagram illustrating an embodiment of a service provider;

FIG. 3 is a schematic diagram illustrating an embodiment of a database;

FIG. 4A is a schematic diagram illustrating an embodiment of the structure of user information;

FIG. 4B is a schematic diagram illustrating an embodiment of the structure of an access record;

FIG. 4C is a schematic diagram illustrating an embodiment of the structure of access point information; and

FIG. 5 is a flowchart of an embodiment of a positioning method for portable devices.

### DESCRIPTION

Positioning systems and methods for portable devices are provided.

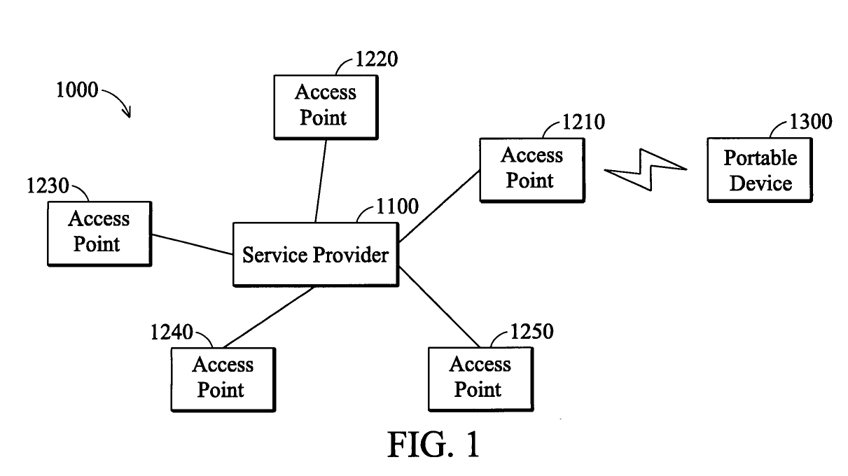

FIG. 1 is a schematic diagram illustrating an embodiment of a positioning system for portable devices.

The system 1000 comprises a service provider 1100, a plurality of access points (1210, 1220, 1230, 1240 and 1250), and at least one portable device 1300. Each access point has identification and set at a specific location, and couples to the service provider 1100. The portable device 1300 has identification, and wirelessly couples to a network provided by the service provider 1100 via one of the access points. The portable device 1300 may be a computer system, a PDA, a mobile phone, and others.

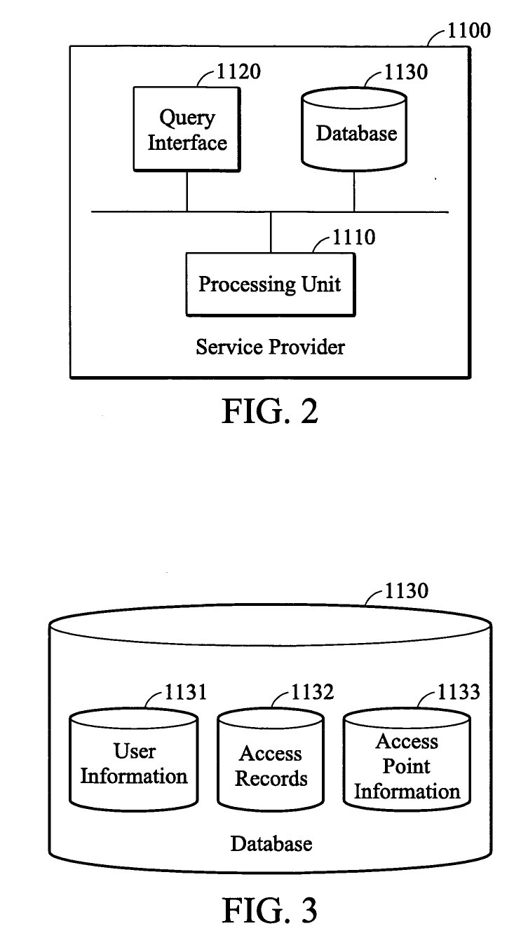

FIG. 2 is a schematic diagram illustrating an embodiment of a service provider.

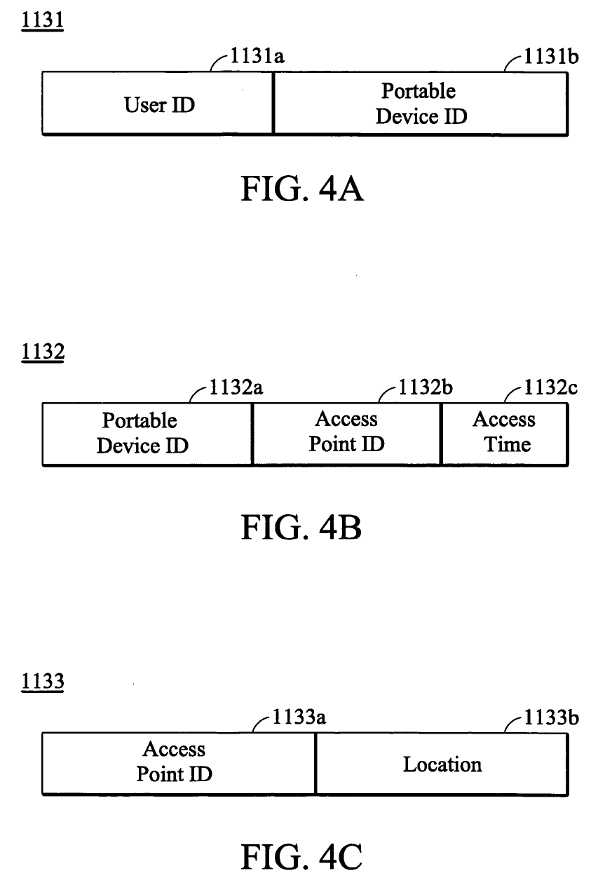

The service provider 1100 comprises a processing unit 1110, at least one query interface 1120, and a database 1130. The processing unit 1110 performs related operations for the service provider 1100. The query interface 1120 receives location queries for specific portable devices from the service provider 1100 or from the portable device 1300. The database 1130 comprises user information 1131, access records 1132, and access point information 1133, as shown in FIG. 3. The user information 1131 comprises user identification 1131a, such as user number or name, and identification of portable device 1131b, such as MAC address of portable device, as shown in FIG. 4A. Respective access record 1132 comprises the identification of portable device 1132a, the identification of access point 1132b, and an access time 1132c, as shown in FIG. 4B. The access records 1132 are generated when portable devices couple to the service provider via the access points. The access point information 1133 comprises the identification of access point 1133a, and the location of access point 1133b, such as the street position data (address), as shown in FIG. 4C. It is understood that respective access points can transmit corresponding identification and location to the service provider 1100, updating the access point information 1133 thereon. Thus, the service provider 1100 can determine the location information of respective portable devices according to the access point information 1133 and the access records 1132. Additionally, the service provider 1100 can determine the location information of respective portable devices at different times according to the access time recorded in the access records 1132, and establish the corresponding routes of portable devices.

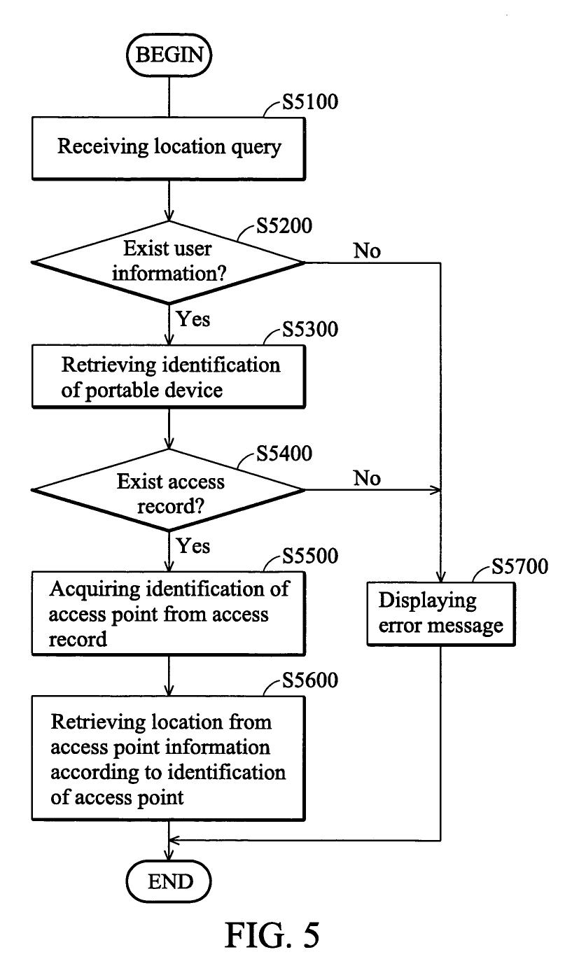

FIG. 5 is a flowchart of an embodiment of a positioning method for portable devices.

In step S5100, a location query for a specific user is received. In step S5200, whether user information for the specific user exists is determined. If not, in step S5700, an errormessage is displayed. If so, in step S5300, identification of the portable device of the specific user is retrieved from the user information. In step S5400, it is determined whether any access record comprises the identification of the portable device. If not, in step S5700, an error message is displayed. If so, in step S5500, the identification of the access point is retrieved from the access record. In step S5600, a location corresponding to the access point is retrieved from the access point information according to the identification of the access point, such that the location information of the portable device of the specific user is determined accordingly.

It is understood that the location query can comprise a time condition. Since each access record comprises an access time, the access records having the access time conforming to the time condition can be used to determine the location information of portable devices at the time condition. For example, the time condition may be a time interval, the access records having the access time within the time interval can be used to determine the location information of portable devices within the time interval. Additionally, when respective access points change its locations, the access points can automatically update the access point information in the service provider, such that the positioning of portable devices remains correct.

Positioning methods for portable devices, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A positioning system for portable devices, comprising:
a plurality of access points, each comprising identification and being set at a location;
at least one portable device, comprising identification, and wirelessly couples to a network via one of the access points; and
a service provider coupled to the access points, providing the network, comprising a database comprising access point information and at least one access record, in which the access point information records the identification and locations corresponding to respective access points, and the access record records at least the identification of the portable device and the identification of the access point coupled thereto,
wherein the service provider determines the location information of the portable device according to the access point information and the access record.

2. The system of claim 1 wherein the access record further records an access time.

3. The system of claim 2 wherein the service provider further determines the location information of the portable device at the access time according to the access point information and the access record.

4. The system of claim 1 wherein respective access points further update corresponding identification and locations to the service provider.

5. The system of claim 1 wherein the access record is generated when the portable device couples to the network provided by the service provider via the access points.

6. The system of claim 1 wherein the database further comprises user information corresponding to the identification of the portable device.

7. The system of claim 6 wherein the service provider further receives specific user information, and retrieves the corresponding location information according to the identification of the portable device corresponding to the specific user information, the access record and the access point information.

8. The system of claim 1 wherein the portable device comprises a computer system, a PDA, or a mobile phone.

9. A positioning system for portable devices, comprising:
a service provider comprising a database, comprising:
access point information recording identifications and locations corresponding to a plurality of access points; and
a plurality of access records, each recording at least identification of one portable device and the identification of one of the access points, in which the access records are generated when the portable devices couple to a network provided by the service provider via the access points,
wherein if a location query for a specific portable device is received, the service provider retrieves at least one of the access records comprising identification of the specific portable device, retrieves the identification of a specific access point from the access record, retrieves a location corresponding to the specific access point from the access point information according to the identification of the specific access point, such that the location information of the specific portable device is determined accordingly.

10. The system of claim 9 wherein respective access records further record an access time.

11. The system of claim 10 wherein the service provider further retrieves at least one of the access records comprising the identification of the specific portable device and the access time conforming to a time condition, retrieves the identification of a specific access point from the access record, retrieves a location corresponding to the specific access point from the access point information according to the identification of the specific access point, such that the location information of the specific portable device at the time condition is determined accordingly.

12. The system of claim 9 wherein respective access points further update corresponding identification and locations to the service provider.

13. The system of claim 9 wherein the database further comprises user information corresponding to the identification of the portable device.

14. The system of claim 13 wherein the service provider further receives specific user information, and retrieves the corresponding location information according to the identification of the portable device corresponding to the specific user information, the access record and the access point information.

15. A positioning method for portable devices, comprising:
receiving a location query for a specific portable device;
retrieving at least one access record comprising identification of the specific portable device, in which the access record is generated when the portable device wirelessly couples to a network via at least one access point, and the access record records at least the identification of the portable device and the identification of the access point;
retrieving the identification of a specific access point from the access record; and
retrieving a location corresponding to the specific access point from access point information according to the identification of the specific access point, such that the location information of the specific portable device is determined accordingly, in which the access point information records the identification and location corresponding to the access point.

16. The method of claim 15 wherein respective access records further record an access time.

17. The method of claim 16 further comprising:
retrieving at least one of the access records comprising the identification of the specific portable device and the access time conforming to a time condition;
retrieving the identification of a specific access point from the access record; and
retrieving a location corresponding to the specific access point from the access point information according to the identification of the specific access point, such that the location information of the specific portable device at the time condition is determined accordingly.

18. The method of claim 15 further comprising respective access points updating the access point information using the corresponding identification and locations.

19. The method of claim 15 wherein the database further comprises user information corresponding to the identification of the portable device.

20. The method of claim 19 further comprising:
receiving specific user information; and
retrieving the corresponding location information according to the identification of the portable device corresponding to the specific user information, the access record and the access point information.
